(19) United States
(12) Patent Application Publication
(10) Pub. No.: US 2015/0342220 A1
(43) Pub. Date: Dec. 3, 2015

(54) PROCESS FOR THE PREPARATION OF FUNCTIONAL PLANT PROTEINS

(71) Applicant: LB LYOpharm S.r.l., Bolzano (IT)

(72) Inventor: Christian REBIÈRE, Merano (IT)

(21) Appl. No.: 14/723,596

(22) Filed: May 28, 2015

(30) Foreign Application Priority Data
May 29, 2014 (IT) RM2014A000285

(51) Int. Cl. A23J 3/34; A23K 1/16; A23L 1/305; A23J 3/14

(52) U.S. Cl. CPC A23J 3/347; A23J 3/14; A23K 1/1631; A23L 1/3055; A23V 2002/00

(57) ABSTRACT

The present invention relates to a process for the preparation of vegetable proteins having increased absorbability with respect to proteins extracted with conventional methods. The invention also relates to the proteins obtainable by said process, their use, and to a precipitate obtainable from step c. of said process and its uses.

The present invention relates to a process for the preparation of vegetable proteins having increased absorbability with respect to proteins extracted by conventional methods. The invention also relates to the proteins obtainable by said process, their use, and to a precipitate obtainable from step c. of said process and its uses.

### STATE OF THE PRIOR ART

Vegetable proteins do not exhibit a good solubility in water; this prevents a good absorption and a good digestibility thereof by humans and non-herbivorous animals (non-herbivores).

Proteins of vegetable origin available on the market normally have a purity of between 45% and 85%, but their digestibility by humans does not exceed, at best, 45%. This means that humans, as well as non-herbivores, are normally unable to effectively absorb proteins of vegetable origin.

In the current state of the art, the purification of vegetable proteins is normally obtained through enzymatic action by cellulases, which are enzymes produced by fungi, bacteria and protozoa, catalyzing the hydrolysis of 1,4-β-D-glycosidic bonds in cellulose, of lichenin and cereal β-D-glucans.

Such processes, as mentioned above, enable a purification, even a rather effective one, of proteins of vegetable origin, yet proteins thus obtained have, e.g. in humans, a <50% absorbability.

Hence, it would be very useful to increase the absorbability of vegetable proteins, in order to make such proteins more useful and effective from a nutritional standpoint.

### SUMMARY OF THE INVENTION

The present invention discloses a process enabling to increase the absorbability of proteins of vegetable origin in humans.

This process, which can be performed on vegetable proteins pre-extracted according to standard methodologies, or starting from plant parts, vegetable tissues or seeds, enables to make proteins of vegetable origin more digestible and absorbable for humans and for the other animals.

Evidently, the proteins treated with the process of the invention will be more digestible not only for humans and omnivores or carnivores, but for herbivores as well.

The process of the invention provides a series of steps and technical conditions that reduce the initial proteins to sizes of between 2,000 and 12,000 daltons, and has a yield of between 60 and 70% of the amount of initial proteins.

The present invention therefore relates to a process for increasing the absorbability of proteins of vegetable origin comprising the following steps:

a. vegetable proteins are put in solution in water in a ratio of between about 0.7:10 and about 1:10, the solution is brought to a temperature between 45° C. and 55° C. at a pH comprised between 6 and 6,5 and the solution is incubated at the indicated temperature and pH with exopeptidase and endopeptidase, wherein said exopeptidase is added to the solution at a time T0 of the incubation, a first exopeptidase is added to the solution at a time T0 +1 hour incubation, a second endopeptidase different from said first endopeptidase is added to the solution at a time T0 +2 hours of incubation and said incubation is carried out for a period between 8 and 16 hours;

b. said incubation is stopped by heating the solution incubated at step a.

c. the solution obtained in step b. is cooled at a temperature comprised between 20° C. and 40° C. and the proteins are separated on a horizontal or vertical separator;

d. the supernatant is recovered in a tank cooled to a temperature between 5° C. and 10° C.;

e. the supernatant obtained in d. is subjected to at least two microfiltrations with microfilters having a decreasing porosity (pitch) comprised between 1.5 μm and 0.4 μm and the filtrate thus obtained is recovered.

Object of the invention are also the proteins obtainable by the process claimed and described in all of its embodiments, the filtrate obtained in step c. of the process, and the uses of said proteins and of said filtrate.

### DETAILED DESCRIPTION OF THE INVENTION

As indicated above, the invention therefore relates to a process for increasing the absorbability of proteins of vegetable origin comprising the following steps:

a. vegetable proteins are put in solution in water in a ratio of between about 0.7:10 and about 1:10, the solution is brought to a temperature comprised between 45° C. and 55° C. at a pH comprised between 6 and 6,5 and the solution is incubated at the indicated temperature and pH with exopeptidase and endopeptidase, wherein said exopeptidase is added to the solution at a time T0 of the incubation, a first exopeptidase is added to the solution at a time T0 +1 hour incubation, a second endopeptidase different from said first endopeptidase is added to the solution at a time T0 +2 hours of incubation and said incubation is carried out for a period between 8 and 16 hours;

b. said incubation is stopped by heating the solution incubated at step a.

c. the solution obtained in step b. is cooled at a temperature comprised between 20° C. and 40° C. and the proteins are separated on a horizontal or vertical separator;

d. the supernatant is recovered in a tank cooled to a temperature between 5° C. and 10° C.;

e. the supernatant obtained in d. is subjected to at least two microfiltrations with microfilters having a decreasing porosity (pitch) of between 1.5 μm and 0.4 μm and the filtrate thus obtained is recovered.

According to a specific embodiment, the abovedescribed process can comprise a further step f. of concentrating the solution obtained in step e. at a concentration of between 50 g protein/liter and 150 g protein/liter.

In a preferred embodiment, said concentrating is carried out at about 100 g protein/liter. The concentrating in f. could be performed by following any suitable technique known to a technician in the field. For instance, the concentrating could be carried out by osmotic membrane.

An example of suitable osmotic membrane is represented by membrane DOW NF245 8038/30 HS or membranes similar thereto.

Furthermore, the process of the invention can comprise a step g. of drying the solution obtained in step e. or the concentrate obtained in step f. optionally after sterilization.

The sterilization can be performed, e.g., by microfiltration on a filter with a 0.2 μm porosity, or by pasteurization, or by gamma irradiation or by any suitable technique known to the technician in the field.

The drying could be performed, in this case as well, by any technique known to the technician in the field, like, e.g., lyophilization or atomization.

Therefore, object of the invention are possible combinations of drying and sterilization described above in the embodiments of step g.

According to one embodiment of the invention, applicable to all embodiments described hereto, the temperature of the incubation performed at step a. of the process could be any one temperature between 45° C. and 55° C., like, e.g., 45, 46, 47, 48, 49, 50, 51, 52, 53, 54, 55° C., for instance a temperature between 49° C. and 51° C., like, e.g., a temperature of about 50° C.

As to the incubation times at step a., in one embodiment of the invention, applicable to all embodiments described hereto, these could be of between 8 and 16 hours, and could therefore be 8, 9, 10, 11, 12, 13, 14, 15, 16 hours, e.g. a time of between 11 and 13 hours, e.g. a time of about 12 hours.

As to the incubation pH at step a., in one embodiment of the invention, applicable to all embodiments described hereto, this could be comprised between 6,0 and 6,5 and could therefore be 6,0; 6,1; 6,2; 6,3; 6,4; 6,5; e.g., 6,2.

In one preferred embodiment, the incubation at step a. will be carried out for 12 hours, at a pH of 6,2 and at a temperature of 50° C.

Again at step a., in one embodiment of the invention applicable to all embodiments described hereto, the exopeptidase could be an exopeptidase of fungal origin, like, e.g., an exopeptidase of Aspergillus oryzae, and it could be used at a concentration of between 25,000 and 35,000 units, e.g. 30,000 units, per Kg of vegetable protein in solution.

In a preferred embodiment, the exopeptidase used could be an exopeptidase of Aspergillus oryzae available on the market, like, e.g., Flavourzyme 500 L or 1000 L, and of this, e.g., 30,000 units per kg of vegetable protein in solution could be used. Again at step a. in one embodiment of the invention applicable to all embodiments described hereto, the first endopeptidase used can be a bacterial endopeptidase derived from Bacillus sp., e.g. an endopeptidase of bacillus licheniformis at a concentration of between 50 and 70 units of enzyme per kg of vegetable protein in solution .

In a preferred embodiment, the first endopeptidase could be an endopeptidase of bacillus licheniformis available on the market like, e.g., Alcalase 2.4 L, and of this, e.g., 60 units per kg of vegetable protein in solution could be used.

Always at step a., in one embodiment of the invention applicable to all embodiments described hereto, the first endopeptidase used may be a bacterial endopeptidase derived from bacillus sp., e.g. an endopeptidase of bacillus amyloliquefaciens at a concentration of between 10 and 20 units of enzyme per kg of vegetable protein in solution.

In a preferred embodiment, the first endopeptidase could be an endopeptidase of bacillus amyloliquefaciens available on the market like, e.g., Neutrase 0.8 L, and of this, e.g., 16 units per kg of vegetable protein in solution could be used.

According to the invention, the stopping of the reaction at step b. can be performed in any embodiment described herein, by treating the reaction mixture of step a. after the reaction time indicated above, at any temperature between 75° C. and 90° C. for periods of time of between about 30 and about 10 minutes. For instance, the reaction may be stopped by treating at a temperature of 75° C. for a period of about 30 minutes, or at a temperature of 90° C. for a period of about 10 minutes.

Preferred temperatures are those that, although stopping the reaction in a., do not damage proteins; therefore, a temperature of about 75° C. is preferred, even though higher temperatures, in the described interval, may be applied.

As to the temperature at step d., always in any embodiment described herein, said temperature could be any temperature of between 5° C. and 10° C., like, e.g., 5° C., 6° C., 7° C., 8° C., 9° C., 10° C., e.g. a temperature of between 7° C. and 9° C., like, e.g., about 8° C. As to the microfiltrations at step e., always in any embodiment described herein, the process provides at least two microfiltrations in filters at decreasing porosity, in a range between 1.2 μm and 0.5 μm.

To carry out the process of the invention, for instance two successive microfiltrations suffice, in which the supernatant obtained in d. is first passed through a 1.2 μm filter, and the filtrate thus obtained is subsequently passed through a 0.45 μm filter. The process of the present invention can be applied to all vegetable proteins.

Among the plants of origin of the proteins of interest, e.g., all plants of alimentary or phytotherapeutical use can be considered.

In one embodiment, the proteins of interest may be, e.g., proteins extracted from leguminous plants, wherein these leguminous plants may be, but are not limited to, peas, soya beans, chickpeas, beans, string beans, lentils and the like.

In another interesting embodiment, such proteins can be, e.g., proteins extracted from nettle or alfalfa, or from other officinal plants.

The process of the invention could be carried out starting from pre-extracted vegetable proteins suitable for alimentary use, or also from parts of plants, vegetable tissues and/or seeds.

In this case, said parts of plants, vegetable tissues and/or seeds will be subjected to conventional extraction processes well-known to the technician in the field, enabling to extract vegetable proteins for alimentary use, such as hydroalcoholic extractions and other conventional types of extraction.

A non-limiting example of vegetable proteins for alimentary use that may be used in the process of the present invention is represented by proteins marketed by Roquette. According to the present invention, said proteins could be solubilized, in step a., in a ratio of between about 1:10, to a ratio of about 0.7:10.

In step c., commercial horizontal or vertical separators, such as Westfalia separators or Alfa Laval separators, can be used.

Furthermore, the invention also relates to vegetable proteins having a high absorbability, obtainable by any embodiment of the process described herein.

The proteins of the invention are characterized in that they are more absorbable, even for non-herbivores, such as, e.g., humans, with respect to vegetable proteins extracted with traditional methods, and in that they have sizes of between 2,000 and 12,000 kDa.

The process of the invention also allows to obtain, at step c., a precipitate that may be dried by conventional techniques, such as, e.g., lyophilization or atomization, and that can then be used to supplement animal feeding, like e.g. livestock (cattle, sheep, swine, equines, rodents, etc.) or pet (dogs, cats, etc.) feeding.

The dried precipitate as described above could then be administered as is or mixed in suitable proportions in moist or dry animal feeds.

Object of the present invention are also such precipitate and its uses.

Hereinafter, an exemplary embodiment of the present invention is reported which is merely intended to illustrate a way to carry out the claimed process, but is absolutely not intended to be limitative thereof.

### EXAMPLES

Conventionally extracted vegetable proteins, in dried form, were dissolved in the amount of 100 g protein/liter of water.

The pre-purified vegetable proteins can also be used commercially. These proteins are dissolved in water in an amount of 70 g/l.

Protein solubilization was performed by using exopeptidase and endopeptidase at the concentrations and times described in the text.

The vegetable protein solution was brought to a temperature of 50° C. This temperature was held throughout the hydrolysis, i.e. 12 hours. The solution pH was brought to 6,2.

In one case, the following enzymes were used:

FLAVOURZYME 1000 L : 30 ml per kg of vegetable protein in solution

Alcalase 2.4 L : 25 ml per kg of vegetable protein in solution

NEUTRASE 0.8 L : 20 ml per kg of vegetable protein in solution

The enzymes were introduced in the solution in the following order after the solution temperature had been stabilized at 50° C.,

T0 : Flavourzyme 1000 L

T0 +1 hour: Alcalase 2.4 L

T0 +2 hours: Neutrase 0.8 L

wherein T0 is the time at which exopeptidase is introduced.

The protein solution was then heated to about 75° C. for 30 minutes to block enzyme action.

The solution was then cooled to a temperature between 40 and 20° C. and then separated on a Westfalia or Alfa Laval horizontal or vertical separator.

The supernatant was put in a cooling tank (at about 8° C.) whereas the precipitate was used for animal feeding after drying.

The supernatant was instead microfiltered with a 1.2 μ filter, and subsequently with a 0.45 μm filter.

The microfiltered solution was then concentrated with a DOW NF245 8038/30 HS osmotic membrane.

The protein solution thus obtained was concentrated to about 100 g/liter and then sterilized by filtration through a 0.2 μ membrane, or pasteurized and then dried by lyophilization or atomization.

The proteins produced are not bitter and can be used for human consumption.

The composition of the proteins having increased absorbability obtained by the described process is represented by polypeptides having sizes of between 2,000 and 12,000 daltons.

Observed production yields were between 60 and 70% of the amount of proteins initially put in solution.

1. A process for increasing the absorbability of proteins of vegetable origin comprising the following steps:
a. vegetable proteins are put in solution in water in a ratio of between about 0.7:10 and about 1:10, said solution is brought to a temperature between 45° C. and 55° C. at a pH comprised between 6 and 6.5, and said solution is incubated at said pH and temperature with exopeptidase and endopeptidase, wherein said exopeptidase is added to said solution at a time T0 of the incubation, a first exopeptidase is added to the solution at a time T0 +1 hour incubation, a second endopeptidase different from said first endopeptidase is added to the solution at a time T0 +2 hours of incubation and said incubation is carried out for a period between 8 and 16 hours;
b. said incubation is stopped by heating;
c. the solution obtained in step b. is cooled at a temperature comprised between 20° C. and 40° C. and the proteins are separated on a horizontal or vertical separator;
d. the supernatant is recovered in a tank cooled to a temperature comprised between 5° C. and 10° C.;
e. the supernatant obtained in d. is subjected to at least two rnicrofiltrations at decreasing porosity in a range between 1.5 μm and 0.4 μm and the filtrate thus obtained is recovered.

2. The process according to claim 1, further comprising step f. concentrating the solution obtained in step e. at a concentration of between 50 g protein/liter and 150 g protein/liter.

3. The process according to claim 2, further comprising step g. drying the concentrate obtained in step f. optionally after sterilization.

4. The process according to claim 1, wherein said exopeptidase is a fungal exopeptidase and wherein between 25,000 and 35,000 units of enzyme per kg of vegetable protein in solution are used.

5. The process according to claim 1, wherein said first endopeptidase is a bacterial endopeptidase deriving from Bacillus sp. and wherein between 50 and 70 units of enzyme per kg of vegetable protein in solution are used.

6. The process according to claim 1, wherein said second endopeptidase is a bacterial endopeptidase deriving from Bacillus sp. and wherein between 10 and 20 units of enzyme per kg of vegetable protein in solution are used.

7. The process according to claim 1, wherein said first endopeptidase is derived from Bacillus licheniformis and said second endopeptidase is derived from Bacillus amyloliquefaciens.

8. Vegetable proteins with enhanced absorbability obtainable by the process according to claim 1.

9. A method of using proteins according to claim 8 comprising preparing food supplements, foods for special medical purposes, or foods for human or animal use from the proteins.

10. The process according to claim 1, wherein the precipitate obtained in step c. is collected and dried.

11. Dried precipitate obtained by the process according to claim 10.

12. A method of using the precipitate according to claim 11 comprising feeding the precipitate to an animal.

13. The process according to claim 2, further comprising step f. drying the solution obtained in step e. optionally after sterilization.
